(19) United States
(12) Patent Application Publication
(10) Pub. No.: US 2007/0067605 A1
(43) Pub. Date: Mar. 22, 2007

(54) Architecture of a parallel-processing multi-microcontroller system and timing control method thereof

(76) Inventor: Jung-Lin Chang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/205,061

(22) Filed: Aug. 17, 2005

(51) Int. Cl. G06F 15/00

(52) U.S. Cl. 712/10

(57) ABSTRACT

The present invention discloses the architecture of a parallel-processing multi-microcontroller system and a timing control method thereof. The multi-microcontroller system of the present invention comprises multiple microcontroller program execution status modules, and under an identical clock, different microcontroller program execution status modules respectively operate at separate clock timings, which is equivalent to that multiple independent microcontrollers simultaneously operate in parallel. The parallel-processing multi-microcontroller system and the timing control method thereof of the present invention can save the portion of hardware cost resulting from adding extra hardware circuits and can effectively overcome the incapability in precisely controlling the timing resulting from timing interferences occurring during executing a program.

### BACKGROUND OF THE INVENTION

1. Field of the Invention

The present invention relates to a multiple-microcontroller system and a timing control method thereof, particularly to a parallel-processing multi-microcontroller system and a timing control method thereof.

2. Description of the Related Art

A microcontroller/microprocessor, denoted by MCU/MPU, is also called single-chip microcomputer. A microcontroller, which is an integrated circuit issuing control commands in a system, can operate without any other auxiliary circuit. A microcontroller provides the functions are almost equivalent to that provided by a miniature computer.

Microcontrollers are widely applied to many fields, such as consumer electronic products, industrial controllers, medical equipments, vehicle controllers, and etc. The microcontroller may cooperate with different peripheral devices, depending on the different application fields, and those different peripheral devices may operate under different handshaking protocols. Common handshaking protocols include: I²C protocol, universal asynchronous receiver/transmitters (UART) protocol, and so on. A microcontroller needs to operate with different peripheral devices according to different protocols. In some applications, the microcontroller needs to execute a process according to a specific timing or a fixed timing for purpose of, e.g., controlling its peripheral devices or measuring waveforms, such as performing pulse width modulation (PWM) to control a motor. Thus, the microcontroller is therefore required to generate a precise timing in order to control its peripheral devices or operate under the precise timing to measure input signals.

To reach the requirements, there are two approaches: software emulations or adding extra special hardware circuit parts. For example, if a microcontroller needs to communicate with one of its peripheral devices by using I²C handshaking protocol, the microcontroller may use the software to emulate I²C handshaking protocol, or a hardware circuit may be extra added to the original circuit of the microcontroller, to perform I²C protocol handshaking. As to the pros and cons of the approaches, software emulation can save the cost of hardware; however, it is hard for a software emulation to precisely generate a specific timing or a fixed timing to control peripheral device. Adding extra hardware circuit parts can generate the desired precise timing, but it increases the cost in hardware aspect. Moreover, different peripheral devices may respectively use different handshaking protocols, and thus, more extra hardware circuits are needed; therefore, the hardware cost is further increased.

Referring to FIG. 1, the architecture of a conventional microcontroller system is shown. Herein, a microcontroller 11 read instructions from a program memory 12 via a program memory bus, and the number of data memories 13 depends on the system need. As the microcontroller 11 must persistently read the program memory 12, the microcontroller 11 accesses the data memory 13 otherwise via a data memory bus. The microcontroller 11 needs to cooperate with multiple different peripheral devices 14 (shown as one hardware block for simplicity) to realize the desired system specification, and the microcontroller 11 controls those different peripheral devices via different peripheral-device-control buses. In such a microcontroller system, when an interrupt occurs, neither program execution sequence nor program execution timing can be predicted. Thus, it would be very difficult or even impossible by software emulation to control the peripheral devices which require a precise fixed timing, or to measure signals accurately.

Referring to FIG. 2, the architecture of a conventional multi-microcontroller system is shown. Herein, via a bus, multiple microcontroller units 25, 26, and 27 share a common data memory 28 and cooperate with multiple peripheral devices 29 (shown as one block for simplicity) to form a multi-microcontroller system. The number of microcontroller units in the multi-microcontroller system depends on the requirement. In this system, as each microcontroller unit has its own program memory, all the microcontroller units can operate independently, and each microcontroller unit may operate under its own clock timing. The disadvantages of this architecture include: the complexity of programming, the requirement of multiple program memories, and the hardware cost of the entire system.

The progressive of semiconductor technology enables a memory to support a higher bandwidth, and thus, a super-scalar/hyper-thread multi-microcontroller system appears. Referring to FIG. 3, the architecture of the super-scalar/hyper-thread multi-microcontroller system is shown. Microcontrollers 31 and 32 share a common program memory 33, each of the microcontrollers 31 and 32 has an instruction buffer. Owing to the instruction buffer, the microcontroller 31 or 32 reads the program memory 33 less frequently, which reduces the probability of interference so that the program can be more likely executed as expected. However, such architecture obviously can only reduce but can not completely avoid the possible occurrence of interference. It is still difficult by software emulation to control those peripheral devices which are operated under precise timings. Besides, the hardware cost of such architecture is still very high.

To solve the abovementioned problems, the present invention proposes a parallel-processing multi-microcontroller system and a timing control method thereof to effectively overcome the interference problem in microcontrollers and reduce the fabrication cost thereof.

### SUMMARY OF THE INVENTION

The primary objective of the present invention is to provide a parallel-processing multi-microcontroller system and a timing control method thereof, wherein multiple microcontroller program execution status modules are provided to parallel execute multiple programs so that each of programs may be independently processed and executed in a desired and precise timing.

Another objective of the present invention is to provide a parallel-processing multi-microcontroller system and a timing control method thereof, wherein a multi-microcontroller control logic is used to control the execution sequence of multiple microcontroller program execution status modules, whereby the hardware is simplified and the overall cost is thus reduced.

Yet another objective of the present invention is to provide a parallel-processing multi-microcontroller system and a timing control method thereof to enable to precisely generate a fixed timing for the periphery device control.

The architecture of a parallel-processing multi-microcontroller system according to the present invention comprises: at least two microcontroller program execution status modules with each microcontroller program execution status module being able to execute at least one program; a multi-microcontroller control logic, which is coupled to those microcontroller program execution status modules and controls those microcontroller program execution status modules to execute their corresponding programs at separate clock timings respectively; and a microcontroller operational logic, which is coupled to each of the microcontroller program execution status modules and performs program sequence control and calculation.

Another aspect of the present invention is a timing control method for a multi-microcontroller system which includes X microcontroller program execution status modules sharing Y program memories, where X is an integer larger or equal to 2 and Y is an integer larger or equal to 1, the system is provided with a basic operating clock frequency of 1/T, and the X microcontroller program execution status modules are separately operated at clock frequencies 1/T1, 1/T2 . . . 1/TX, wherein 1/TX denotes the operating clock frequency of the Xth microcontroller program execution status module, and each of the operating clock frequencies 1/T1, 1/T2 . . . 1/TX is smaller than 1/T, wherein
1/T1+1/T2+ . . . +1/TX≦Y*1/T, where X≧2 and Y≧1.

Yet another aspect of the present invention is that among those X microcontroller program execution status modules, a dedicated one is assigned to process interrupt requests.

To enable the objectives, technical contents, characteristics, accomplishments of the present invention to be more easily understood, the embodiments of the present invention are to be described below in detail in conjunction with the attached drawings.

### BRIEF DESCRIPTION OF THE DRAWINGS

FIG. 1 is a diagram of the architecture of a conventional microcontroller system.

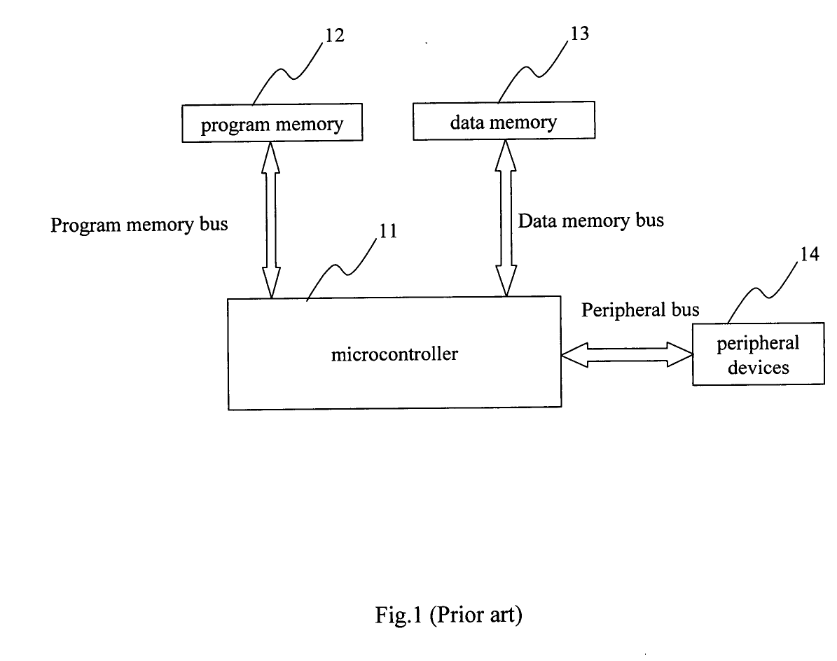

FIG. 2 is a diagram of the architecture of a conventional multi-microcontroller system.

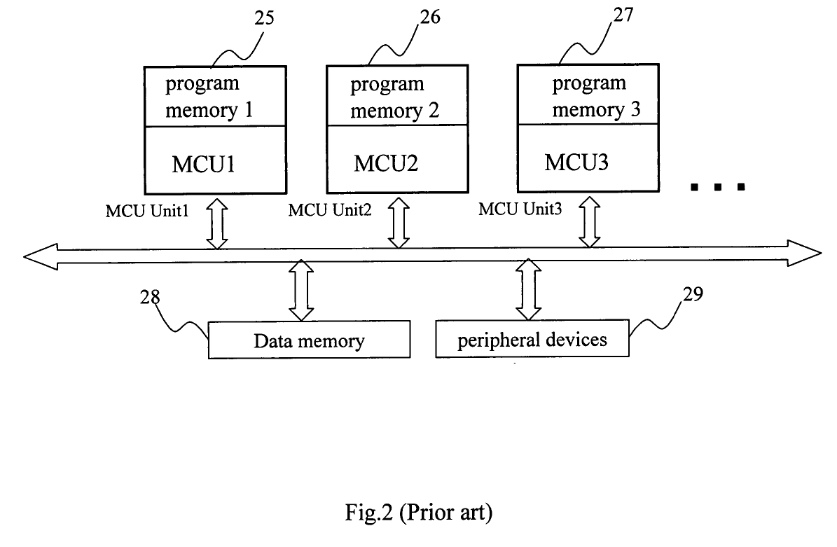

FIG. 3 is a diagram of the architecture of another conventional multi-microcontroller system.

FIG. 4 is a diagram illustrating a high-level architecture of the present invention.

FIG. 5 is a block diagram of the architecture according to one embodiment of the present invention.

FIG. 6 is a block diagram of the architecture according to another embodiment of the present invention.

FIG. 7 is a timing diagram showing the clock timing of further another embodiment according to the present invention, which comprises four microcontroller program execution status modules.

FIG. 8 is a diagram of the architecture according to still another embodiment of the present invention.

### DETAILED DESCRIPTION OF THE INVENTION

The present invention provides a parallel-processing multi-microcontroller system to enable desired and precise parallel execution of multiple programs without interference and to enable the generation of a desired and precise timing.

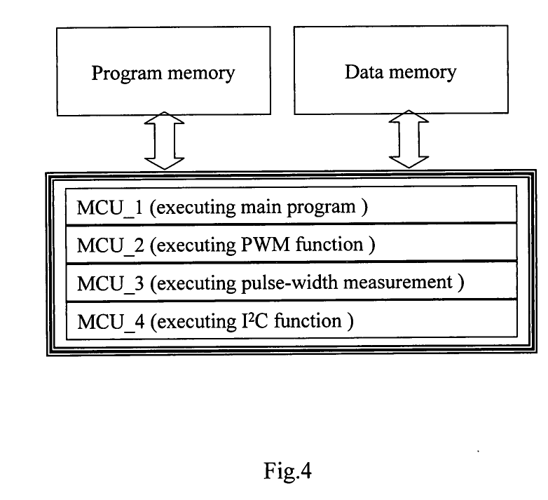

Referring to FIG. 4, a diagram of the architecture according to one embodiment of the present invention is shown. A multi-microcontroller system (MMCU) comprises X independently-operating microcontrollers MCU_1, MCU_2, MCU_3, and MCU_4 (for the purpose of illustration and simplicity, X=4 in this embodiment); MCU_1 is used to execute the main program; MCU_2 is used to generate pulse width modulation (PWM) waveforms; MCU_3 is used to measure the pulse widths of input signals; and MCU_4 is used to execute I²C handshaking protocol.

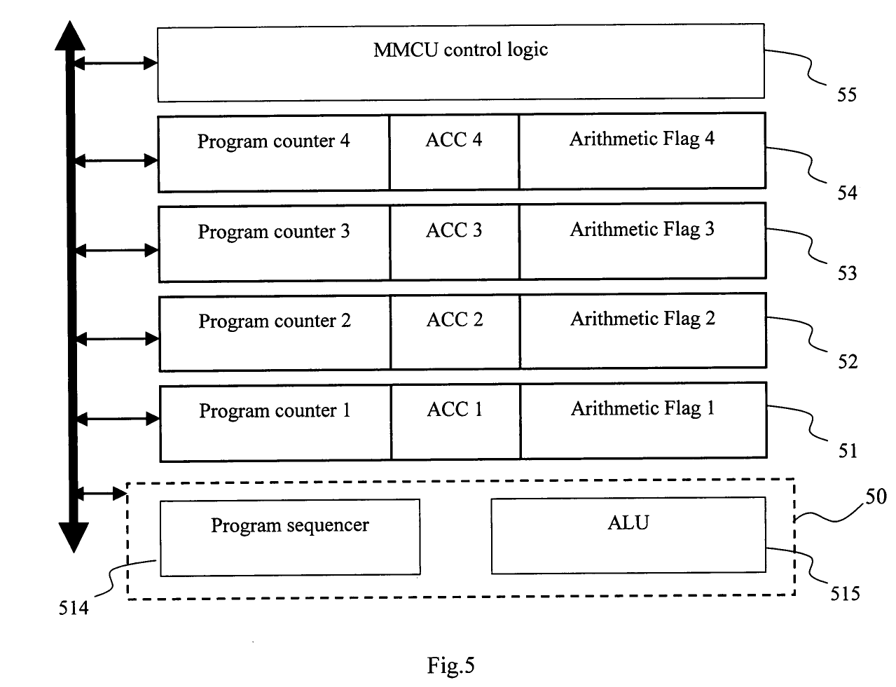

Referring to FIG. 5, a block diagram of the architecture according to an embodiment of the present invention is shown. There are four microcontroller program execution status modules 51, 52, 53, and 54 corresponding to microcontrollers MCU_1, MCU_2, MCU_3, and MCU_4 respectively. The microcontroller program execution status module 51, which comprises a program counter 1, an accumulator 1, and an arithmetic flag 1, is part of MCU_1. The microcontroller program execution status module 52, which comprises a program counter 2, an accumulator 2, and an arithmetic flag 2, is part of MCU_2. The microcontroller program execution status module 53, which comprises a program counter 3, an accumulator 3, and an arithmetic flag 3, is part of MCU_3. The microcontroller program execution status module 54, which comprises a program counter 4, an accumulator 4, and an arithmetic flag 4, is part of MCU_4. A multi-microcontroller control logic 55 is used to select different microcontroller program execution status modules to operate at different timings.

Each of those four microcontroller program execution status modules 51, 52, 53, and 54 executes at least one program independently. The multi-microcontroller control logic 55 is coupled to those four microcontroller program execution status modules 51, 52, 53, and 54, and enables those four microcontroller program execution status modules 51, 52, 53, and 54 to execute their corresponding programs at separate clock timings respectively. A microcontroller operational logic 50 is coupled to those four microcontroller program execution status modules 51, 52, 53, and 54 and performs program sequence control and calculation in a dynamic manner (to be explained hereinafter). The microcontroller operational logic 50 further comprises a program sequencer 514, and an arithmetic logic unit (ALU) 515, and both of them are coupled to a bus for transmitting and receiving signals. Each of the four microcontroller program execution status modules 51, 52, 53, and 54 has a program counter, an accumulator, and an arithmetic flag respectively.

In the abovementioned architecture, the microcontroller program execution status modules 51, 52, 53, and 54 dynamically share the microcontroller operational logic 50. Each of the microcontroller program execution status modules 51, 52, 53, and 54, in function-wise, combining with the microcontroller operational logic 50, dynamically constitute a complete and fully-functional microcontroller.

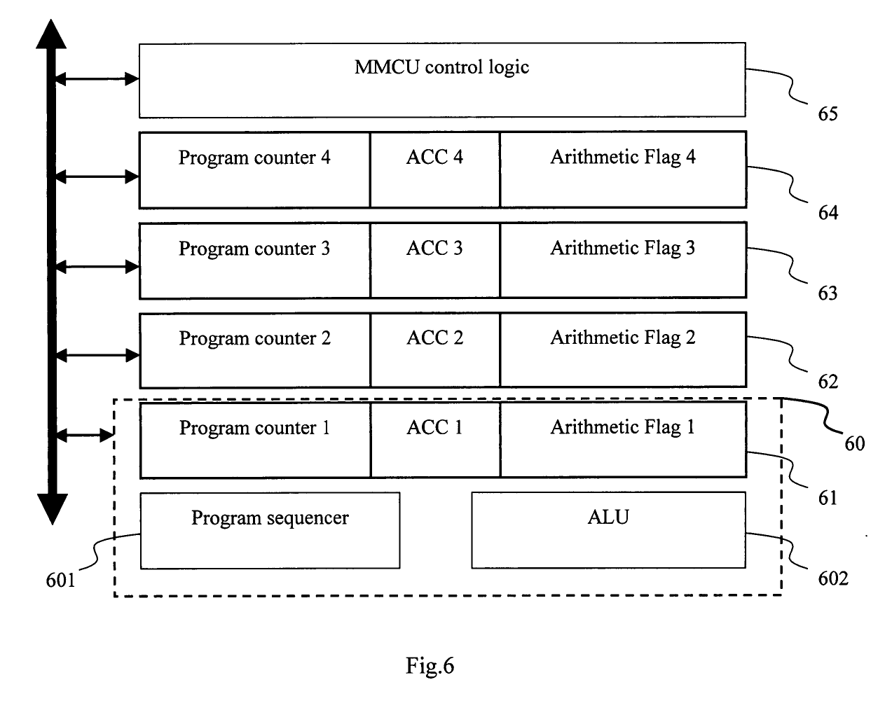

Referring to FIG. 6, a block diagram of the architecture according to another embodiment of the present invention is shown. The architecture comprises: a microcontroller 60, which can execute at least one program; three microcontroller program execution status modules 62, 63, and 64, each of which can also execute at least one program; and a multi-microcontroller control logic 65, which is coupled to the microcontroller 60 and three microcontroller program execution status modules 62, 63, and 64 and enables the microcontroller 60 and three microcontroller program execution status modules 62, 63, and 64 to respectively execute their corresponding programs at separate clock timings.

The microcontroller 60 comprises a program counter 1, an accumulator 1, an arithmetic flag 1, a program sequencer 601, and an arithmetic logic unit 602. The microcontroller program execution status modules 62, 63, and 64 respectively have their own program counters, accumulators, and arithmetic flags. The program counter 1, accumulator 1, and arithmetic flag 1 can also be regarded as a microcontroller program execution status module 61.

The architectures in FIG. 5 and FIG. 6 are equivalent in substance. The purpose of FIG. 6 is to explain that a designer may use a conventional microcontroller as the microcontroller 60, and add extra circuit parts to constitute the architecture of the present invention. The design work is thus simpler.

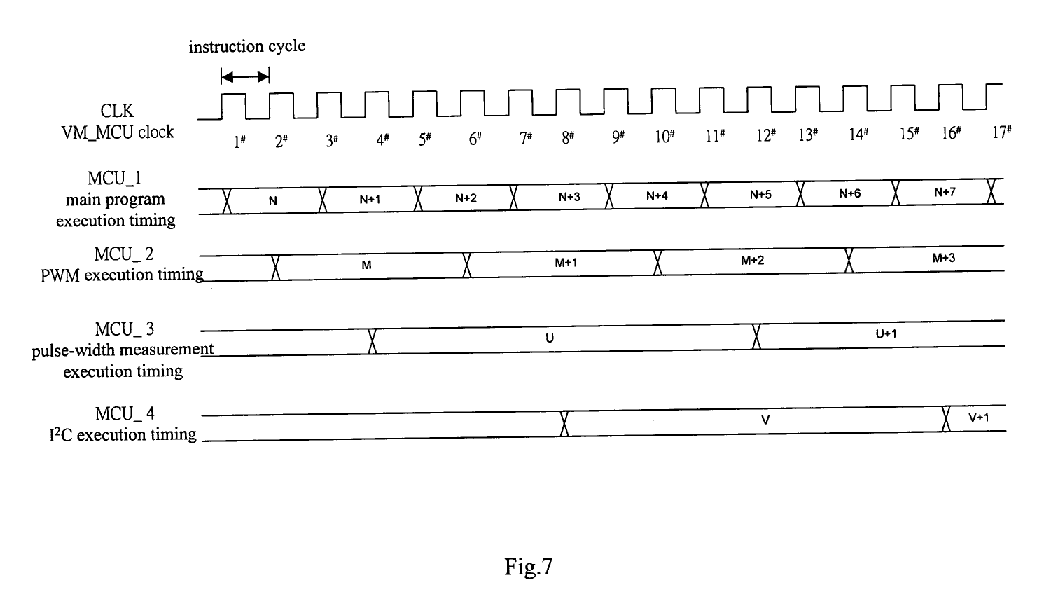

Referring to FIG. 7, a clock-timing diagram of four microcontroller program execution status modules according to further another embodiment of the present invention is shown. In cycle 1# of the system clock (CLK), the multi-microcontroller control logic 55 determines the microcontroller program execution status module 51 to operate, i.e. to execute the program of MCU_1. In cycle 2# of the clock (CLK), the multi-microcontroller control logic 55 determines the microcontroller program execution status modules 52 to operate, i.e. to execute the program of MCU_2. In cycle 3# of the clock (CLK), the multi-microcontroller control logic 55 determines the microcontroller program execution status module 51 to operate, i.e. to follow up the program execution of MCU_1. In cycle 4# of the clock (CLK), the multi-microcontroller control logic 55 determines the microcontroller program execution status module 53 to operate, i.e. to execute the program of MCU_3. In cycle 5# of the clock (CLK), the multi-microcontroller control logic 55 determines the microcontroller program execution status module 51 to operate, i.e. to follow up the program execution of MCU_1. In cycle 6# of the clock (CLK), the multi-microcontroller control logic 55 determines the microcontroller program execution status module 52 to operate, i.e. to follow up the program execution of MCU_2, and so on. In the architecture of the present invention, it can be readily understood that one may add more microcontroller program execution status modules for concurrently executing more programs.

As an overview, the timing at which MCU_1 executes instructions is in cycles 1#, 3#, 5#, 7#, . . . ; the Nth action of the main program is executed in cycle 1#, and the N+1th action of the main program is executed in cycle 3#, and the N+2th action of the main program is executed in cycle 5#, and so on; Thus, the operating clock frequency of MCU_1 is ½ of the basic operating clock frequency of the multi-microcontroller system. The timing at which MCU_2 executes instructions is in cycles 2#, 6#, 10#, 14#, . . . ; the Mth action of PWM function is executed in cycle 2#, and the M+1th action of PWM function is executed in cycle 6#, and the M+2th action of PWM function is executed in cycle 10#, and so on; Thus, the operating clock frequency of MCU_2 is ¼ of that the basic operating clock frequency of the multi-microcontroller system. The timing at which MCU_3 executes instructions is in cycles 4#, 12#, . . . ; the Uth action of pulse-width measurement is executed in cycle 4#, and the U+1th action of pulse-width measurement is executed in cycle 12#, and so on; Thus, the execution clock frequency of MCU_3 is ⅛ of that the basic operating clock frequency of the multi-microcontroller system. The timing at which MCU_4 executes instructions is in cycles 8#, 16#, . . . ; the Vth action of I²C function is executed in cycle 8#, and the V+1th action of I²C function is executed in cycle 16#, and so on; Thus, the operating clock frequency of MCU_4 is ⅛ of that the basic operating frequency of the multi-microcontroller system.

As the microcontrollers MCU_1, MCU_2, MCU_3, and MCU_4 shown in FIG. 7 operates at separate clock timings, they can share a common program memory, and no instruction buffers are required to reduce the interference between different microcontrollers; Thus, the hardware arrangement is much less costly and the associated software is much less complex.

Based on the above description, it is corollary that more than one common program memory can be used and shared among the MCU's. (e.g. four MCU's share two common program memories). The relationship among MCU's, program memories, and clock frequencies is:
1/T1+1/T2+ . . . +1/TX≦Y*1/T (1),
wherein 1/T is the basic operating clock frequency provided by the system; X is the number of MCU's, and the operating clock frequencies of the Xth MCU's is 1/TX, where 1/T1, 1/T2 . . . 1/TX is lower than 1/T; and Y is the number of program memories.

In the example shown in FIG. 7, X=4, Y=1, and the clock frequency provided by the system is shared by ½T, ¼T, ⅛T, and ⅛T. The present invention is not limited to such an arrangement, and the designer may easily conceive other alternatives, such as, for example, sharing the basic frequency by ¼T, ¼T, ¼T and ¼T. As another example, one may dynamically stop allocating the clock frequency to one or more “idle” MCU's that are not in use, i.e., sharing the basic clock frequency only by active MCU's, for example, by way of ½T, ¼T, ¼T, and 0.

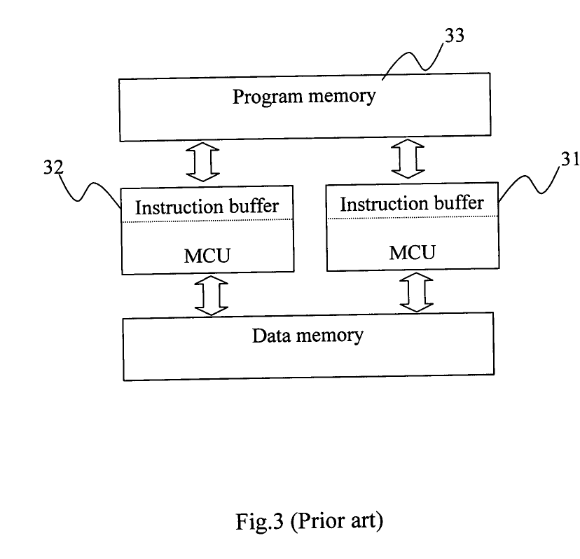

It is to be noted that the aforementioned clock frequency sharing arrangement is another novel aspect of the present invention, irrespective of whether it is applied to the hardware architecture shown in FIG. 5 and FIG. 6 or applied to a conventional architecture, such as the one shown in FIG. 3. In other words, the MCU's mentioned in conjunction with FIG. 7 may be either a conventional MCU, such as the one shown in FIG. 3, or a dynamic MCU, (i.e. a microcontroller program execution status module plus a microcontroller operational logic), such as the one shown in FIG. 5 and FIG. 6.

In the description heretofore where it describes that “the basic operating clock frequency provided by/to the system is 1/T”, it is intended to mean that the minimum operating clock frequency is 1/T, regardless what the originally generated clock frequency of the system is. For example, in a double-frequency circuit which operates twice per cycle (once in the positive semi-cycle and once in the negative semi-cycle), “1/T” in the present invention is twice the original clock frequency provided by the system. When the operating clock frequency for multiple MCU's is otherwise provided, the “1/T” in the present invention refers to the operating frequency provided thereby. Further state it in detail: if the original clock frequency provided by (or to) the system is 1 MHz, while the system generates a 3 MHz operating clock frequency via a circuitry method; then, the so-called “the basic operating clock frequency provided by the system (1/T)” in the present invention is to be 3 MHz. In other words, “1/T” in the present invention refers to the operating clock frequency actually used in the operation of the system.

Based on the frequency-sharing method mentioned above, when the system receives an interrupt request, the interrupt service program can be assigned to one or a fixed number of dedicated MCU's so that the other MCU's will never be interrupted. In addition, such an arrangement to allocate dedicated interrupt service MCU (or some MCU's) is applicable not only to the architectures shown in FIG. 5 and FIG. 6 but also to the architecture shown in FIG. 3. When all of the MCU's are fully loaded yet a new interrupt request occurs, this novel interrupt arrangement may ensure that the timings of most MCU's can be precisely controlled.

It should be further noted that different timings for different functional combinations of multiple MCU's may be reprogrammed via the multi-microcontroller control logic 55, and the reprogramming of the timings should meet the specifications of the system and the peripheral devices. For example, a faster handshaking protocol needs a timing of higher frequency.

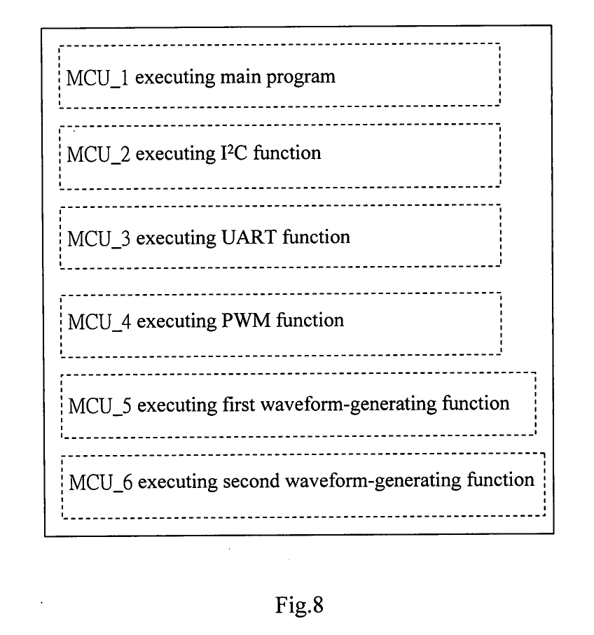

Referring to FIG. 8, a diagram of the architecture according to still another embodiment of the present invention is shown. This architecture has six microcontrollers: the first microcontroller MCU_1 executes the main program; the second microcontroller MCU_2 executes I²C function; the third microcontroller MCU_3 executes UART function; the fourth microcontroller MCU_4 executes PWM function; the fifth microcontroller MCU_5 executes a first waveform-generating function; the sixth microcontroller MCU_6 executes a second waveform-generating function. Each of the microcontrollers respectively has a corresponding microcontroller program execution status modules, i.e. X=6.

According to the present invention, a designer may employ any number of microcontroller program execution status modules to achieve a desired performance in equivalent to employing the same number of microcontroller. It is also possible for each microcontroller to execute multiple programs in order to accomplish capacity/efficiency balance, and cost/performance balance. Furthermore, when different handshaking protocols and communications with various peripheral devices are required, the present invention can easily generate accurate fixed timings for different peripheral devices, precise measurement of the pulse width of signals, etc. Possible applications include but not limited to the aforementioned applications, SPI handshaking protocol, Timer program, and other pulse-width measurement program for input signals. The present invention not only greatly reduces hardware cost but also provide more flexibility to the use of microcontrollers.

The present invention utilizes multiple microcontroller program execution status modules in dynamic combination with a microcontroller operational logic to execute respective programs, and a multi-microcontroller control logic enables the multiple dynamic microcontrollers to respectively execute their corresponding programs at separate clock timings.

Accordingly, the present invention proposes an architecture of a parallel-processing multi-microcontroller system and a timing control method thereof in order to process multiple programs parallel, which not only can overcome the problem in conventional controllers that timing is disturbed and cannot be precisely controlled, but also can simplify the hardware architecture with reduced cost.

Those embodiments described above are to enable the persons skilled in the art to understand, make, and use the present invention but not intended to limit the scope of the present invention. Any equivalent modification and variation under the spirit of the present invention disclosed herein should be included in the claimed scope of the present invention.

What is claimed is:

1. A parallel-processing multi-microcontroller system, comprising:
at least two microcontroller program execution status modules, wherein each of said microcontroller program execution status modules can execute at least one program;
a multi-microcontroller control logic, coupled to said microcontroller program execution status modules, and controlling said microcontroller program execution status modules to execute their corresponding programs at separate clock timings;
a microcontroller operational logic, coupled to said microcontroller program execution status modules, and performing program sequence control and calculation.

2. The parallel-processing multi-microcontroller system according to claim 1, wherein one of said microcontroller program execution status modules and said microcontroller operational logic are integrated into a microcontroller.

3. The parallel-processing multi-microcontroller system according to claim 1, wherein at least one of said microcontroller program execution status modules is dedicatedly assigned to process an interrupt request.

4. The parallel-processing multi-microcontroller system according to claim 1, wherein said microcontroller operational logic further comprises a program sequencer and an arithmetic logic unit, and said program sequencer and said arithmetic logic unit are coupled to a bus for transmitting/receiving signals.

5. The parallel-processing multi-microcontroller system according to claim 1, wherein each of said microcontroller program execution status modules further comprises a program counter and an arithmetic flag, and said program counter and said arithmetic flag are coupled to a bus for transmitting/receiving signals.

6. The parallel-processing multi-microcontroller system according to claim 1, wherein control signals of said microcontroller program execution status modules are transmitted or received via a handshaking protocol to peripheral devices.

7. The parallel-processing multi-microcontroller system according to claim 6, wherein said handshaking protocol is selected from the group consisting of I²C protocol, Universal Asynchronous Receiver/Transmitters (UART) protocol, Serial Peripheral Interface (SPI), pulse width modulation (PWM), pulse-width measurement program, and Timer program.

8. The parallel-processing multi-microcontroller system according to claim 1, further comprising a program memory, which stores programs and is coupled to said microcontroller program execution status modules via a program memory bus.

9. The parallel-processing multi-microcontroller system according to claim 8, wherein said microcontroller program execution status modules read the programs said program memory can be installed inside or outside said microcontrollers.

10. The parallel-processing multi-microcontroller system according to claim 9, wherein said programs include: main program, PWM (pulse width modulation) waveform generating program, pulse-width measurement program for input signal, I²C handshaking protocol program, UART (Universal Asynchronous Receiver/Transmitters) handshaking protocol program, SPI (Serial Peripheral Interface) handshaking protocol program, and Timer program.

11. The parallel-processing multi-microcontroller system according to claim 1, further comprising a data memory, which is coupled to said microcontroller program execution status modules via a data memory bus.

12. A timing control method for a multi-microcontroller system,
wherein said multi-microcontroller system comprises X microcontroller program execution status modules and sharing Y program memories, where X≧2 and Y≧1, and said multiple microcontrollers system is provided with a basic clock frequency of 1/T; and
wherein said timing control method comprising:
said X microcontroller program execution status modules separately operate at operating clock frequencies of 1/T1, . . . 1/T2 . . . 1/TX under the following condition:
1/T1+1/T2+ . . . +1/TX≦Y*1/T
where 1/TX is the operating clock frequency of the Xth microcontroller program execution status module, and each of the operating clock frequencies of 1/T1, 1/T2 . . . 1/TX is smaller than 1/T.

13. The timing control method for a multi-microcontroller system according to claim 12, wherein at least one of said microcontroller program execution status module is dedicatedly assigned to process an interrupt request.

14. The timing control method for a multi-microcontroller system according to claim 12, wherein said Y program memories can be installed inside or outside said microcontrollers.

15. The timing control method for a multi-microcontroller system according to claim 12, wherein said each of X microcontroller program execution status modules is combined with a corresponding microcontroller operational logics to form a complete microcontroller.

16. The timing control method for a multi-microcontroller system according to claim 12, wherein each of said X microcontroller program execution status modules is dynamically integrated with one and the same microcontroller operational logic to form a dynamic microcontroller.

17. The timing control method for a multi-microcontroller system according to claim 12, wherein 1/T1, 1/T2 . . . 1/TX is denoted by 1/Tn (n=1, 2, . . . X), and
when n=1, 2 . . . X−1, 1/Tn=(½ⁿ)*Y*(1/T); and
when n=X, 1/Tn=(½^{(X-1)})*Y*(1/T).

18. The timing control method for a multi-microcontroller system according to claim 12, wherein said X microcontroller program execution status modules equally share said the basic clock frequency, i.e. 1/T1=1/T2= . . . =1/TX.

19. The timing control method for a multi-microcontroller system according to claim 12, wherein when x said microcontroller program execution status modules are not being used among said X microcontroller program execution status modules, only (X-x) said microcontroller program execution status modules share said the basic clock frequency, and 1/T1+1/T2+ . . . +1/TX-x≦Y*1/T.

20. An interrupt-processing method for a multi-microcontroller system, wherein said multi-microcontroller system comprises X microcontroller program execution status modules, and said interrupt-processing method comprises: assigning at least one of said microcontroller program execution status module to dedicatedly process an interrupt request.

21. The interrupt-processing method for a multi-microcontroller system according to claim 20, wherein each of said X microcontroller program execution status modules is combined with a corresponding microcontroller operational logics to form a complete microcontroller.

22. The interrupt-processing method for a multi-microcontroller system according to claim 20, wherein each of said X microcontroller program execution status modules is dynamically integrated with one and the same microcontroller operational logic to form a dynamic microcontroller.
